(19) United States
(12) Patent Application Publication
(10) Pub. No.: US 2020/0357190 A1
(43) Pub. Date: Nov. 12, 2020

(54) SYSTEM AND METHOD FOR ENHANCING A 3D RENDERING OF A LIDAR POINT CLOUD

(71) Applicant: SAP NATIONAL SECURITY SERVICES, INC., Newtown Square, PA (US)

(72) Inventors: Brian REID, Fairfax, VA (US); Jonathan BOUGIE, Hamilton, VA (US)

(21) Appl. No.: 16/866,968

(22) Filed: May 5, 2020

Related U.S. Application Data
(60) Provisional application No. 62/843,753, filed on May 6, 2019.

(51) Int. Cl. G06T 19/20; G06T 15/08; G01S 17/89

(52) U.S. Cl. CPC G06T 19/20; G06T 2207/10028; G01S 17/89; G06T 15/08

(57) ABSTRACT

A system(s) and method(s) for improved visualization includes a processor for receiving a signal from a LIDAR system measuring a target site. The received signal includes a collection of points representing a 3D space and a signal strength for each point. The processor may execute at least one of an intensity, color, size and opacity modules stored in a memory to adjust at least one attribute of a point of the point cloud based on the signal strength of that point to generate an improved 3D image of the point cloud for display on a display. By correlating the received signal strength with at least one of an intensity, color, size and opacity, an improved and more visually pleasing 3D image of the point cloud may be obtained and displayed.

### CROSS-REFERENCE TO RELATED APPLICATIONS

This application claims priority to the U.S. provisional patent application Ser. No. 62/843,753, filed May 6, 2019. Priority to this U.S. provisional patent application is expressly claimed, and the disclosure of the provisional application is hereby incorporated herein by reference in its entirety and for all purposes.

### FIELD OF THE INVENTION

The present invention relates to systems and methods for correlating a received signal strength indicator (RSSI) of a received LIDAR signal, which is used to generate a 3-dimensional (3D) rendering of a point cloud, with intensity, color, size and/or opacity in order to generate an enhanced 3D rendering of the point cloud with enhanced intensity, color, enhanced size and/or enhanced opacity.

### BACKGROUND OF THE INVENTION

A light detection and ranging (LIDAR) system is a remote topographic depth sensing technology which includes a transmitter to transmit light in the form of laser pulses to a surface and a sensor to receive a collection of 3D points (also referred to as a point cloud) in order to measure ranges (variable distances) to the surface. Based on the received point cloud, the LIDAR system outputs a 3D rendering of the point cloud to visualize the surface tomography. The LIDAR system can be mounted on a mobile object, such as a land, aerial or aquatic vehicle, in order to scan a surface of a target and obtain the point cloud. The point cloud represents a 3D shape or feature of the target. Each 3D point of the point cloud has X, Y and Z coordinates which represent a single point in 3D space and includes measurement data of the signal strength for each point. The collection of 3D points (the point cloud) is used to visualize, e.g., on a display device, the 3D shape of the surface topography scanned by the LIDAR system.

A need exists for an improved visualization of the 3D image outputted from existing LIDAR systems. An improved or enhanced 3D rendering of the point cloud is important so that a user may more easily and efficiently view, understand and analyze the target surface topography scanned by the LIDAR system.

### SUMMARY OF THE INVENTION

The system, device, method, arrangement, user interface, computer program, processes, etc. (hereinafter each of which will be referred to as system, unless the context indicates otherwise) of the present invention address problems in prior art systems.

The system and method of the present invention relate to enhancing a 3D rendering of a point cloud received by a LIDAR system. The invention relates to a system and method for generating an improved, more visually pleasing, 3D rendering of the point cloud, by adjusting, manually by a user input and/or automatically by a processor, the intensity, color, size and opacity of the 3D rendering of the point cloud based on the signal strength measurement or a received signal strength indicator (RSSI) provided by an existing LIDAR system. The improved or enhanced 3D rendering of the point cloud may be visualized on a rendering device, such as on at least one of a display, a web graphics library (WebGL), a virtual reality headset, a thin-client viewer or web based user interface, a user interface (UI), a printer, and the like.

The present invention relates to a LIDAR system having a LIDAR scanner mounted on a land, aerial or aquatic vehicle, such as a small tank, rover or drone. The LIDAR scanner may include a transmitter for illuminating or transmitting pulsed laser light (i.e., laser radar) to a target surface. The LIDAR scanner may further include a sensor or receiver for sensing and measuring the reflected pulses reflected from the target surface. The LIDAR scanner of the present system may be one that is low cost.

One embodiment of the invention relates to a system and method for rendering an enhanced 3D image comprising a processor configured to receive a LIDAR signal having a received signal strength indicator (RSSI) and a memory operatively coupled to the processor where the memory includes an intensity module, a size module, and an opacity module. A display may be operatively coupled to the processor and the display is configured to display an original (or unadjusted) 3D rendering of the received LIDAR signal. The processor is configured to execute at least one of: the intensity module to adjust an intensity of color of the original 3D rendering; the size module to adjust a size of the original 3D rendering; and the opacity module to adjust an opacity of the original 3D rendering. In response to the RSSI, the processor is configured to execute the intensity, size and opacity modules to generate an enhanced (or adjusted) 3D rendering by adjusting the original 3D rendering. For example, an increase in the RSSI is configured to cause: (1) the intensity module to increase the intensity of color of the original 3D rendering; (2) the size module to increase the size of the original 3D rendering; and (3) the opacity module to increase the opacity of the original 3D rendering. Further, the display is configured to display the enhanced 3D rendering obtained from application of at least one of the intensity, size and opacity modules.

In another embodiment of the invention relates a system or method of rendering an enhanced 3D image wherein the system a processor configured to receive a LIDAR signal having a point cloud representing a target site in three dimensions and to receive a received signal strength indicator (RSSI) for each point of the point cloud. The system further comprises a memory operatively coupled to the processor and storing an intensity module, a size module, and an opacity module. The processor is configured to execute: the intensity module to adjust an intensity of color of at least one point of the point cloud; the size module to adjust a size of the at least one point of the point cloud; and the opacity module to adjust an opacity of the at least one point of the point cloud. In response to the RSSI, the processor is configured to execute at least one of the intensity, size and opacity modules to adjust at least one of the intensity of color, the size and the opacity of the at least one point to generate the enhanced 3D image of the point cloud. For example, an increase in the RSSI is configured to cause: (1) the intensity module to increase the intensity of color of the at least one point of the point cloud; (2) the size module to increase the size of the at least one point of the point cloud; and (3) the opacity module to increase the opacity of the at least one point of the point cloud. Further, the system comprises a display operatively coupled to the processor and configured to display the enhanced 3D image obtained from application of at least one of the intensity, size and opacity modules.

In one embodiment, a non-transitory computer readable medium storing computer instructions, which when executed by a processor, configure the processor to perform a method for rendering an enhanced 3D image, where the method comprises steps of receiving, by a processor, a LIDAR signal having a received signal strength indicator (RSSI), and displaying, by a display operatively coupled to the processor, an original 3D rendering of the LIDAR signal received in the receiving step. The method further comprises the step of executing, by the processor, in response to the RSSI at least one of: an intensity module to adjust an intensity of color of the unadjusted 3D rendering; a size module to adjust a size of the original 3D rendering; and an opacity module to adjust an opacity of the original 3D rendering, where the intensity, size and opacity modules are stored in a memory operatively coupled to the processor. The method further comprises the step of generating, by the executing step, an enhanced 3D rendering by adjusting the original 3D rendering, where an increase in the RSSI is configured to cause: the intensity module to increase the intensity of color of the original 3D rendering; the size module to increase the size of the original 3D rendering; and the opacity module to increase the opacity of the original 3D rendering. A displaying step displays, by the display, the enhanced 3D rendering obtained from application of at least one of the intensity, size and opacity modules.

In another embodiment, a non-transitory computer readable medium having computer instructions, which when executed by a processor, configure the processor to perform a method for rendering an enhanced 3D image, where the method comprises a step of receiving, by a processor, a LIDAR signal having a point cloud representing a target site in three dimensions and a received signal strength indicator (RSSI) for each point of the point cloud. The method further comprises a step of executing, by the processor, in response to the RSSI at least one of: an intensity module to adjust an intensity of color of at least one point of the point cloud; a size module to adjust a size of the at least one point of the point cloud; and an opacity module to adjust an opacity of the at least one point of the point cloud, where the intensity, size and opacity modules are stored in a memory operatively coupled to the processor. A step of generating, by the executing step, generates the enhanced 3D image of the point cloud, where an increase in the RSSI is configured to cause: the intensity module to increase the intensity of color of the at least one point of the point cloud; the size module to increase the size of the at least one point of the point cloud; and the opacity module to increase the opacity of the at least one point of the point cloud. A displaying step, via a display operatively coupled to the processor, displays the enhanced 3D image obtained from application of at least one of the intensity, size and opacity modules.

Thus, it is an object of the invention to visualize an enhanced 3D representation of a measured or scanned target site by mapping the RSSI of a LIDAR signal to at least one of intensity, color, size and/or opacity of points in a point cloud. Such an enhanced 3D image may provide a user a more visually pleasing and easy to view interactive 3D image of the point cloud thus allowing to more efficiently notice and extract information and/or points of interest.

### BRIEF DESCRIPTION OF THE DRAWINGS

The present invention is explained in further detail in the following exemplary embodiments with reference to the figures, where the features of the various exemplary embodiments are combinable. In the drawings:

FIG. 1 is a block diagram of a system for rendering an enhanced 3D image, in accordance with the invention;

FIG. 2 is a flow chart of a method for rendering an enhanced 3D image, in accordance with the invention; and

FIG. 3 is a flow chart of an alternative method for rendering an enhanced or correlated 3D image, in accordance with the invention.

### DETAILED DESCRIPTION OF THE PRESENT SYSTEM

The present invention relates to an enhanced or adjusted 3D rendering of a LIDAR point cloud based on a correlation between the RSSI of the received LIDAR signal reflected from points of the point cloud, and an attribute, such as intensity, color, size and/or opacity of the rendered points of the point cloud.

The system and method for improved visualization of an output from a LIDAR system measures a target space to produce a point cloud where each point represents a single point in 3D space and includes a measurement of the signal strength for that point. A rendering device uses this output from the LIDAR system to create a 3D representation of the measured target space. To create the 3D render of the point cloud, a 3D rendering library may be used with an application programming interface (API). To generate the improved visualization of the point cloud, the present system and method, adjust at least one of the intensity of color, the color, the size and the opacity of at least one point based on the signal strength measurement, such as a received signal strength indicator (RSSI), provided by the LIDAR system.

The embodiments of the invention are discussed and explained below with reference to the accompanying drawings. Note that the drawings are provided as an exemplary understanding of the invention and to schematically illustrate particular embodiments of the invention. The skilled artisan will readily recognize other similar examples that are equally within the scope of the invention. The drawings are not intended to limit the scope of the invention as defined in the appended claims. Further, in the following description, for purposes of explanation rather than limitation, illustrative details are set forth such as architecture, interfaces, techniques, element attributes, etc. However, it will be apparent to those ordinary skill in the art that other embodiments that depart from these details would still be understood to be within the scope of the appended claims. Moreover, for purposes of clarity, detailed descriptions of well-known devices, circuits, tools, techniques, and methods are omitted so as not to obscure the description of the present invention. The term and/or and formatives thereof should be understood to mean that only one or more the recited elements may need to be suitably present (e.g., only one recited element is present, two of the recited elements may be present, etc., up to all of the recited elements may be present) in an embodiment in accordance with the claimed recitation.

In one embodiment, the land or aerial vehicle may be provided with a LIDAR scanner and a video camera, such as a first-person view (FPV) camera, to provide a video stream (e.g., a live video stream) in addition to the measurement data of the reflected pulses provided by the LIDAR scanner. The on-board camera (e.g., FPV camera), mounted on the vehicle, may be connected to a transmitter mounted on the vehicle. The transmitter may send a video signal to a receiver which may be operatively linked to a viewing or rendering device for viewing, including live-stream viewing, by a user.

One embodiment of the system includes a processor configured to receive and process the reflected pulses (LIDAR signal) received from the LIDAR scanner after reflection from the target surface. The reflected LIDAR signal may be wirelessly received by the processor through an antenna(s) and a sensor/receiver which may be part of, and integrated with the LIDAR scanner/transmitter, for example. The processor may process the differences in the laser return times, such as the round-trip time of the LIDAR signal traveling from the LIDAR scanner to the target and back from the target to the LIDAR scanner, and/or differences in wavelengths/frequencies of transmitted and received LIDAR signals to account for frequency shift, known as a doppler shift, due to a moving target and/or platform of the LIDAR scanner such as a drone, to generate a 3D representation of the target surface. The LIDAR signal may include a point cloud, where each point of the point cloud includes or is associated with a measurement of a received signal strength indicator (RSSI) of a signal reflected from each of the particular points of the target and received by a sensor, where the RSSI may be processed by the processor. Each 3D point of the point cloud has X, Y and Z coordinates which represent a single point in 3D space. The processor or controller may be operatively coupled to a memory and may execute computer instructions stored on or in the memory which may be a tangible non-transitory computer readable memory medium, where the computer instructions configure the processor or controller to perform desired acts.

In another embodiment, a rendering device may be operatively coupled to the processor. The rendering device is configured to visualize and/or display the output (e.g., the target 2D and/or 3D topology based on reflected pulses reflected from various points of the target) of the mounted LIDAR system which is processed by the processor (e.g., the LIDAR signal) to provide the rendering device with a video signal for display as a 3D rendering of the target surface or site. The displayed 3D rendering is a rendering of the point cloud which represents a 3D shape or feature of the target site. The rendering device configured to display the enhanced or adjusted 3D rendering of the adjusted pointed cloud may be the same or a different rendering device used to display the original (or unadjusted) 3D rendering of the received LIDAR signal. The rendering device may be a display or monitor which may be a stand-alone device or part of another device such as a mobile phone or computer, a web graphics library (WebGL) such as for example Potree™, a virtual reality headset such as for example the HTC Vive™ Virtual Reality System, a thin-client viewer or web based user interface such as for example the Apollo GraphQL Client™, a user interface, a printer, or the like. The UI may be configured to allow a user to select the manner of display where, for example, the user may select to display both the adjusted and original 3D rendering on the same screen, which may be split in any desired form, such as split into equal or different sizes, side by side, or top and bottom, for example. The UI may be configured to allow a user to select the type of mapping (of RSSI to intensity/color/size/opacity), such as linear, logarithmic, exponential, for example.

In one embodiment of the invention, the rendering device may be the Apollo GraphQL Client™ (Apollo™ User Interface or Apollo™ UI). The Apollo™ UI uses the information from the LIDAR signal representing the point cloud (e.g., X, Y and Z coordinates representing a single point in 3D space and the measurement of the signal strength or RSSI for each point) to create the 3D representation of the measured/scanned target site measured by the LIDAR scanner and processed by the processor. Alternatively or in addition, the rendering device may display the enhanced or adjusted 3D rendering from the original 3D rendering. To create the 3D render, a rendering library, such as for example an open source 3D library called Three.js™ may be used. The rendering library may handle all the complex 3D rendering of the point cloud while providing an application programming interface (API) to make 3D application and processing less complex. The generated 3D render may be an interactive 3D image which may be interacted with by a user via a user interface (UI), such as the Apollo™ UI.

To create an improved or enhanced visualization of the point cloud, the processor, which is operatively coupled to the rendering device, may be configured to modify attributes of the rendered (e.g., displayed) points of the point cloud based on the RSSI. For example, the attributes may be at least one of the intensity, color, size and/or opacity of the points.

In another embodiment, the processor is operatively coupled to a memory which may include one of or any combination of an intensity module, color module, a size module and/or an opacity module in order to adjust or enhance the 2D and/or 3D rendering of the point cloud and generate an adjusted or enhanced 2D and/or 3D rendering. The intensity, color, size and/or opacity modules may be adjusted based on the RSSI or signal strength of each point of the point cloud in order to generate an enhanced 2D and/or 3D rendering of the point cloud. The intensity, color, size and/or opacity modules may be configured to be adjusted by a user input that may manually adjust the RSSI to directly or indirectly adjust the map attributes including the intensity, color, size and/or opacity of a selected point cloud, selected and adjusted via a user interface that receives the user input and is operatively coupled to the processor. Alternately or in addition, the intensity, color, size and/or opacity of a selected point cloud may be adjusted automatically by the processor based on the received/reflected LIDAR signal processed by the processor. A stronger RSSI may be indicative of a target site in closer proximity to the LIDAR scanner mounted on the vehicle, while a weaker/smaller RSSI may be indicative of a target site further away in proximity as compared to a point having a stronger or larger RSSI.

In another embodiment of the system, the intensity module may be configured to adjust the intensity or brightness of the color (or gray scale) of a point of the point cloud based on a signal strength measurement, such as the RSSI, provided by the LIDAR scanner or system to the processor. The intensity module may be configured to use a linear scale to map the signal strength or RSSI to the intensity of the color used in the 3D rendering. For example, the intensity module may be configured such that a stronger signal strength or stronger RSSI of a point adjusts the 3D rendering of that point to be a brighter color in order to generate an enhanced 3D rendering which is displayed on the rendering device. Accordingly, based for example on a linear scale, an increase in the RSSI of a point may be configured to cause the intensity module to linearly increase the intensity of color of that point displayed on the 3D rendering in order to generate an enhanced 3D rendering based on changes of the signal strength/RSSI resulting in changes in the intensity of color. Similarly, a decrease in the RSSI of a point may be configured to cause the intensity module to decrease, such as linearly decrease, the intensity of color of that point displayed on the 3D rendering in order to generate an enhanced 3D rendering. It should be noted that the present invention is equally applicable to 2D rendering and thus all references herein to 3D rendering may also include 2D rendering.

Alternatively, or in addition, a color module may be configured to use a linear scale to map the signal strength to the color used in the 3D rendering. Based for example on a linear scale between visible red and violet end points with different colors in between the well-known visible color spectrum of white light, the color module is configured to change the color of the point displayed on the 3D rendering in order to generate an enhanced 3D rendering based on signal strength or RSSI of at least one point of the point cloud. For example, on the linear scale, the color red may be associated with a strong/large RSSI and the color violet may be associated with a weak/small RSSI with changing colors between the red and violet based on the RSSI values of the reflected LIDAR signals reflected from different points of the target cloud, such that an increase in the RSSI level or value of a point may be configured to cause the color module to change or move the color of the point displayed on the 3D rendering towards red endpoint to generate an enhanced 3D rendering. Similarly, a decrease in the RSSI value of a point may be configured to cause the color module to display the point displayed on the 3D rendering in changed color moving away from the red endpoint toward the violet endpoint, such as changing from red to orange to yellow to green to blue to indigo to violet, as the RSSI value decreases, in order to generate an enhanced 3D rendering.

Alternatively or in addition to other modules such as the intensity and color modules, a size module may be configured to adjust the size of a point of the point cloud based on the RSSI or signal strength measurement provided by the LIDAR scanner or system to the processor of the system. The size module may be configured to use a linear scale to map the signal strength to the size of the point displayed in the 3D rendering. For example, the size module may be configured such that a stronger signal strength or stronger/larger RSSI of a point adjusts the 3D rendering of that point to be a larger size in order to generate an enhanced 3D rendering which is rendered such as displayed on the rendering or display device. Accordingly, based for example on a linear scale, an increase in the RSSI of a point may be configured to cause the size module to linearly increase the size of that point displayed on the 3D rendering in order to generate an enhanced 3D rendering based on signal strength and size. Similarly, a decrease in the RSSI of a point may be configured to cause the size module to linearly decrease the size of that point displayed on the 3D rendering in order to generate an enhanced 3D rendering.

Alternatively or in addition to the intensity, color and/or size modules, an opacity module may be configured to adjust the opacity of a point of the point cloud based on a signal strength measurement, such as the RSSI, provided by the LIDAR scanner or system to the processor of the present system. The opacity module may be configured to use a linear scale to map the signal strength to the opacity of the point displayed in the 3D rendering. For example, the opacity module may be configured such that a stronger signal strength or stronger RSSI of a point adjusts the 3D rendering of that point to be more opaque in order to generate an enhanced 3D rendering which is displayed on the rendering device. Accordingly, based for example on a linear scale, an increase in the RSSI of a point may be configured to cause the opacity module to increase the opacity of that point displayed on the 3D rendering in order to generate an enhanced 3D rendering based on signal strength and size. A decrease in the RSSI of a point may be configured to cause the opacity module to decrease the opacity of that point displayed on the 3D rendering in order to generate an enhanced 3D rendering. While the mapping of RSSI to intensity, color, size and/or opacity of a point is described as being linear, it should be understood that other types of mapping may be used such as based on user selection via the UI, such as exponential and/or logarithmic mapping, for example, where the mapping type may be a function of the screen size, where linear mapping may be used for larger display or screen sizes, while logarithmic mapping may be used for smaller display or screen sizes, where at least one of XYZ axis is logarithmic, for example. It should also be understood that displaying a 3D rendering may also include any type of rendering of 2D and/or 3D presentation rendered on any type of a rendering device, such as displayed on a display, or printed by a printer, for example. Further, the attributes may be changed between predetermined minimum and maximum values. For example, a weak RSSI may result in the opacity (and/or any of the other attributes) to be reduced up to a minimum level, as further reducing the opacity below the minimum level may render the weak target not opaque enough or too transparent to notice on the adjusted map or rendering.

Accordingly, at least one of the intensity, color, size and opacity is adjusted between predetermined minimum and maximum values. Further, at least one of the intensity, color, size and opacity is adjusted in response to a value of another one of intensity, color, size and opacity being outside predetermined minimum and maximum values.

In one embodiment, the processor may be configured to change at least one of the attributes based on the value of another attribute. Illustratively, the processor may be configured to change the opacity of a point or collection of points in response to the size of the point or collection of points being below a first threshold or above a second different threshold. For example, when the size of a point(s) is below the first threshold due to a weak RSSI which would normally result in low opacity/high transparent value for such a point(s), then in response to such a small size, the processor may be configured to change the opacity from the normally calculated low opacity (calculated based on the weak RSSI) to a higher opacity, so that the small sized point(s) becomes more noticeable. Otherwise, such a small sized point(s) having the normally calculated low opacity may be difficult to be noticed as a target. In such cases, the processor causes display of an indication of a hyper-adjusted map, such as a blinking indicator, that indicates the map includes hyper-points that have at least one attribute which is adjusted in response to a value of another attribute. The blinking indicator may be the hyper-points themselves blinking, or another blinking indicator displayed in an area of the map outside the target.

In one embodiment, the rendering device used to display the enhanced or adjusted 3D rendering of the point cloud may be the Apollo GraphQL Client™ (Apollo™ User Interface or UI). The Apollo™ UI uses the information from the LIDAR signal representing the point cloud (e.g., X, Y and Z coordinates representing

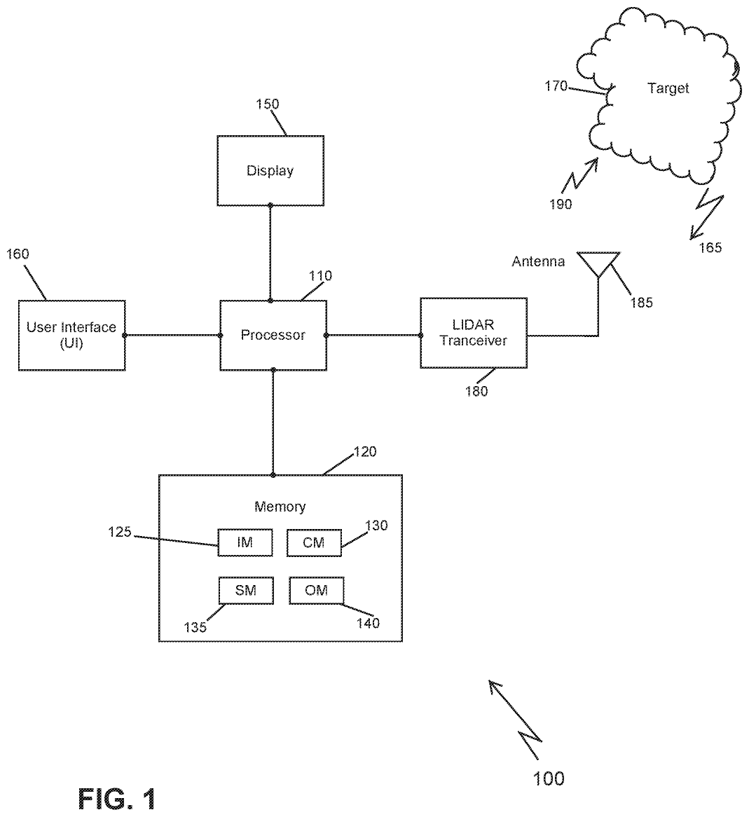

As illustrated in FIG. 1, the system 100 according to one embodiment includes a processor 110 and a memory 120 operatively coupled to the processor 110. The memory 120 is a non-transitory computer-readable tangible medium storing computer instructions, computer programs and/or modules, which when executed by the processor 110 configure the processor to perform desired steps, functions or acts. For example, as shown in FIG. 1, memory 120 may include one or any of a combination of an intensity module (IM) 125, a color module (CM) 130, a size module (SM) 135 and/or an opacity module (OM) 140 which are configured to adjust corresponding attributes. For example, the attribute of the IM 125 may be an intensity or brightness of color (or of a gray scale) of a rendered point cloud, the attribute of the CM 130 may be color, the attribute of the SM 135 may be size, and the attribute of the OM 140 may be opacity/transparency. The system 100 further may include a rendering device such as a display 150 and a user interface (UI) 160, which are operatively coupled to the processor 110.

In this embodiment, processor 110 may be configured to receive an RSSI of received LIDAR signal 165 reflected from target 170 and received by transceiver 180 through antenna 185. Received LIDAR signal 165 may represent a 3D point (having X, Y and Z coordinates) of target 170 or may represent a collection of 3D points (i.e., a point cloud) of target 170. As shown in FIG. 1, transceiver 180 transmits a transmitted LIDAR signal 190 through antenna 185 toward target 170 which reflects transmitted LIDAR signal 190 back to antenna 185 as received LIDAR signal 165 received by antenna 185. Transceiver 180 may process received LIDAR signal 165 to obtain the RSSI. The transceiver 180 may be mounted on, for example, a land, aquatic or aerial vehicle, for scanning target 170 and transmitting and receiving LIDAR signals 165, 190 to target 170. It should be understood by a skilled person in the art that the transceiver 180 may alternatively be a separate receiver/sensor and a separate transmitter which are connected to the same antenna 185 through a switch or duplexer for either transmitting or receiving based on the state of the duplexer controlled by processor 110 or by a local processor/controller of transceiver 180. Alternately or in addition, the separate receiver and separate transmitter may be connected to two separate individual antennas. Transceiver 180 may include a modulator and encoder to modulate and encode any transmitted signals, and may include a demodulator and decoder to demodulate and decode any received signals, as is well-known, thus extracting information from received signals and providing the extracted information to the processor in digital form for processing, where analog signals are converted to digital format using an analog to digital (ND) converters, and digital signals, e.g., from the processor, are converted to analog form as needed by digital to analog (D/A) converters. The A/D and D/A converters may be stand-alone converters between digital and analog devices and/or incorporated in the elements of system 100, such as in transceiver 180 and processor 110, for example.

In one embodiment, processor 110 may be configured to cause the display of a 3D rendering of the point cloud on a display 150 which may be interacted with by a user via user interface 160. Alternatively or in addition, processor 110 may be configured to execute one or a combination of IM 125, CM 130, SM 135 and/or OM 140 stored in memory 120 in order to adjust at least one attribute of the 3D rendering and/or correlate the RSSI with the at least one attribute to generate a correlated or enhanced 3D rendering for display on display 150. Display 150 may be an interactive display which may be interacted with by a user via user interface 160.

In another embodiment of the system, display 150 may be configured to display a 3D rendering of the point cloud on display 150 under the control of processor 110 which executes at least one of IM 125, CM 130, SM 135 and OM 140 to adjust at least one attribute of the 3D rendering displayed on display 150 based on the RSSI and may be further configured to cause display 150 to display an enhanced or adjusted 3D rendering of the point cloud. Processor 110 may be configured to adjust the 3D rendering in response to the RSSI, for example, automatically and/or by a user input at UI 160. Display 150 may be configured to display the adjusted or enhanced 3D rendering under the control of processor 110. The adjusted or enhanced 3D rendering is a correlated 3D rendering in which at least one attribute of at least one point of the point cloud has been adjusted or correlated based on the RSSI of the at least one point. A skilled person in the art would understand displaying the 3D rendering and displaying the enhanced 3D rendering may be the same or a different display, which may or may not be operatively coupled to each other.

In yet another embodiment, processor 110 may be configured to cause display 150 to display an enhanced, correlated or adjusted 3D rendering of the point cloud absent or without displaying an initial or first unadjusted 3D rendering. In this embodiment, for example, processor 150 may be configured to execute one or a combination of IM 125, CM 130, SM 135 and/or OM 140 stored in memory 120 to correlate the RSSI received by processor 110 with the at least one attribute to generate a correlated or enhanced 3D rendering for display on display 150. Processor 110 may be configured to adjust the point cloud based on the correlation between the RSSI and the one or more attributes, for example, automatically and/or via a user input at the user interface, and cause the display 150 to display the adjusted or correlated 3D rendering. The adjusted or enhanced 3D rendering is a correlated 3D rendering in which at least one attribute of at least one point of the point cloud has been adjusted or correlated based on the RSSI of the at least one point.

In one embodiment, memory 120 is configured to store intensity module (IM) 125 which is configured to be executed by processor 110. IM 125 may be configured to adjust the intensity or brightness of the color (or gray scale) of a point of the point cloud representing target 170 based on a signal strength measurement, such as the RSSI, provided by LIDAR transceiver 180 to processor 110. IM 125 may be configured to use a linear, exponential and/or logarithmic scale to map the signal strength or RSSI to the intensity of the color used in the 3D rendering. For example, IM 125 may be configured to use a linear scale such that a stronger signal strength or stronger/larger RSSI of a point adjusts the 3D rendering of that point to be a brighter color in order to generate an enhanced 3D rendering which is configured to be displayed on display 150. Accordingly, based for example on a linear scale, an increase in the RSSI of a point may be configured to cause IM 125 to linearly increase the intensity of color of that point in order to generate an enhanced 3D rendering based on changes of the signal strength/RSSI of reflected/received LIDAR signal 165 resulting in changes in the intensity of color. Similarly, a decrease in the RSSI of a point may be configured to cause IM 125 to decrease, such as linearly decrease, the intensity of color of that point displayed on the 3D rendering in order to generate an enhanced 3D rendering. The enhanced 3D rendering is displayed on display 150 under the control of processor 110.

Alternatively, or in addition, memory 120 may be configured to store color module (CM) 130 which is configured to be executed by processor 110. CM 130 may be configured to adjust or change the color of a point of the point cloud representing target 170 based on a signal strength measurement, such as the RSSI of reflected/received LIDAR signal 165, provided by LIDAR transceiver 180 to processor 110. CM 130 may be configured to use a linear, exponential and/or logarithmic scale to map the signal strength to the color used in the 3D rendering displayed on display 150. Based for example on a linear scale between red and violet end points with different colors in between of the well-known color spectrum of visible white light, CM 130 is configured to change the color of that point in order to generate an enhanced 3D rendering based on signal strength or RSSI of reflected/received LIDAR signal 165 reflected from at least one point of the point cloud. For example, on the linear scale, the color red may be associated with a strong RSSI and the color violet may be associated with a weak RSSI with changing colors between the red and violet based on the RSSI, such that an increase in RSSI of a point may be configured to cause CM 130 to change or move the color of the point displayed on the 3D rendering towards red to generate an enhanced 3D rendering. Similarly, a decrease in the RSSI of a point may be configured to cause CM 130 to change or move the color of the point displayed on the 3D rendering away from the red endpoint toward the violet endpoint, such as changing from red to orange to yellow to green to blue to indigo to violet in order to generate an enhanced 3D rendering for display on display 150.

Alternatively or in addition to IM 125 and CM 130, memory 120 may be configured to store size module (SM) 135 which is configured to be executed by the processor 110. SM 135 may be configured to adjust the size of a point of the point cloud of target 170 based on the RSSI or signal strength measurement of a reflected/received LIDAR signal 165, where the RSSI is determined and provided by LIDAR transceiver 180 to processor 110. SM 135 may be configured to use a linear, exponential and/or logarithmic scale to map the signal strength to the size of the point used in the 3D rendering displayed on display 150. For example, in one embodiment, SM 135 may be configured such that a stronger signal strength or stronger RSSI of a point adjusts that point to be a larger size in order to generate an enhanced 3D rendering which is displayed on display 150. Accordingly, based for example on a linear scale, an increase in the RSSI of a point may be configured to cause SM 135 to linearly increase the size of that point in order to generate an enhanced 3D rendering based on signal strength and size for display on display 150. Similarly, a decrease in the RSSI of a point may be configured to cause SM 135 to linearly decrease the size of that point in order to generate an enhanced 3D rendering for display on display 150.

Alternatively or in addition to IM 125, CM 130 and/or SM 135, memory 120 is configured to store opacity module (OM) 140 which is configured to be executed by processor 110. OM 140 may be configured to adjust the opacity of a point of the point cloud based on a signal strength measurement, such as the RSSI of a reflected/received LIDAR signal 165, where the RSSI is determined and provided by LIDAR transceiver 180 to processor 110. OM 140 may be configured to use a linear, exponential and/or logarithmic scale to map the signal strength to the opacity of the point used in the 3D rendering displayed on display 150. For example, OM 140 may be configured such that a stronger signal strength or stronger RSSI of a point adjusts that point to be more opaque in order to generate an enhanced 3D rendering which is displayed on display 150. Accordingly, based for example on a linear scale, an increase in the RSSI of a point may be configured to cause OM 140 to increase the opacity of that point in order to generate an enhanced 3D rendering based on signal strength and size. A decrease in the RSSI of a point may be configured to cause OM 140 to decrease the opacity of that point down to a predetermined minimum opacity (i.e., become more translucent) in order to generate an enhanced 3D rendering for display on display 150. The various attributes may be limited to be adjusted between predetermined maximum and minimum values, which may be pre-stored in the memory 120 or provided by a user through UI 160. The maximum and minimum values may be adjusted by the user through UI 160.

As shown in FIG. 1, display 150 is operatively coupled to processor 110. Under the control of processor 110, display 150 is configured to display the enhanced 3D rendering which has been enhanced by processor 110 based on a correlation between the RSSI of reflected/received LIDAR signal 165 and one or any combination of IM 125, CM 130, SM 135 and/or OM 140 executed by processor 110.

Processor 110 may be a singular processor or a collection of distributed processors, such as having processors and/or controllers included with various system elements where, for example, LIDAR transceiver 180, display 150 and UI 160 may have their own dedicated processors that, collectively with other distributed processors of system 100, are referred to as processor 110 of system 100.

At least one of the elements of system 100 may be operatively connected to a network, such as the Internet or a local area network, for communicating through the network with a remote server, a remote memory, a remote UI and/or a remote display, where the server may have its own processor, memory, UI and display as is well-known. All or some parts or elements of system 100 may be connected to the network and server, directly or indirectly, though well-known connections, which may be wired or wireless, such as via wire cables, fiber optics, satellite or other RF links, Bluetooth™, e.g. Similarly, the various elements of system 100 may be interconnected, directly or indirectly, though well-known connections, which may be wired or wireless, such as via wire cables, fiber optics, Bluetooth™, as well as long range RF links such as satellite. Thus, processor 110, memory 120, as well as other elements of system 100 shown in FIG. 1 may be co-located near each other, and/or may be remote from each other and operationally coupled or connected though a local area network and/or the Internet though wired or wireless secure connections where communications therebetween may be encrypted, for example.

Processor 110 may also be operatively coupled to the user interface (UI) 160. In one embodiment, a user may interact with display 150, directly or indirectly. Alternatively, or in addition, a user may use UI 160 to manually input information, such as to manually change or input the RSSI value (to manually adjust attributes of the point cloud as desired) or to select which module(s) to be executed by processor 110, to cause processor 110 to execute one or any combination of IM 125, CM 130, SM 135 and/or OM 140. Alternatively, or in addition, the UI may be configured to allow a user to select the manner of display where, for example, the user may select to display both the adjusted and original 3D rendering on the same screen, which may be split in any desired form, such as split into equal or different sizes, side by side, or top and bottom, for example. UI 160 may be configured to allow the user to select whether to display both the adjusted and original 3D rendering simultaneously, or sequentially or whether to display only the adjusted 3D rendering without displaying any unadjusted 3D rendering. UI 160 may be configured to allow a user to select the type of mapping (of RSSI to intensity/color/size/opacity), such as linear, logarithmic, exponential, and the like.

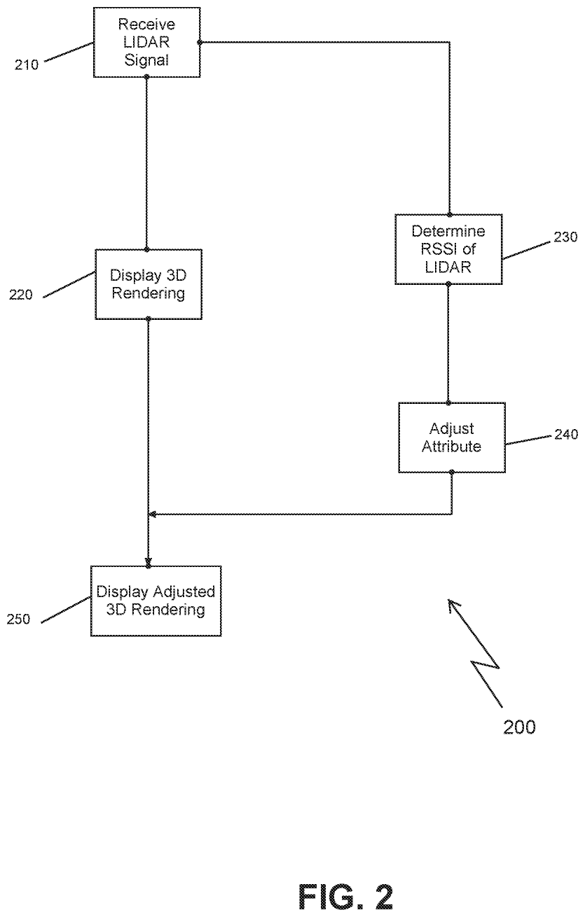

As illustrated in FIG. 2, a method 200 according to the invention includes a step 210 for receiving a LIDAR signal by, for example, the LIDAR transceiver 180 mounted on a land, aerial or aquatic vehicle or platform used for scanning a target site 170 by transmitting and receiving LIDAR signals 190, 165 through the antenna 185. LIDAR signal 165 received in receiving step 210 is reflected from target site 170 and received by transceiver 180.

In a first displaying step 220, a 3D rendering of the point cloud of reflected LIDAR signal 165 received in receiving step 210 is visualized on display 150 or any rendering device, for example.

In a determining step 230, the RSSI of reflected LIDAR signal 165 received in step 210 is determined, by for example, the LIDAR transceiver 180 which is operatively coupled to processor 110.

In an adjusting step 240, an attribute of a point on the point cloud is adjusted in response to the RSSI of reflected LIDAR signal 165 identified in determining step 230. The attribute to be adjusted in step 240 may be one or a combination of any one of an intensity of color, a color, a size and/or an opacity of at least one point of the point cloud, for example using intensity, color, size and/or opacity modules 125, 130, 135, 140 stored in memory 120 and executed by processor 110. Further, in response to one attribute being outside a predetermined range, another attribute may be adjusted by processor 110 and a hyper-adjusted map may be displayed including at least one hyper-point that has at least one attribute which is adjusted in response to a value of another attribute. For example, in response to the size of a point being below a predetermined minimum size due to a weak RSSI, the corresponding calculated opacity associated with the weak RSSI is increased. This allows the small sized point to be more noticeable than otherwise would have been if the opacity was reduced to a level dictated by the weak RSSI level. As described above, when a hyper-adjusted map is displayed, processor 110 may cause display of an indication that the displayed map is a hyper-adjusted map, such as a blinking indicator, that indicates the map includes hyper-points that have at least one attribute which is adjusted in response to a value of another attribute.

In an adjusted displaying step 250, an adjusted or enhanced 3D rendering of the point cloud is shown on display 150 or any other rendering device. In order to obtain the adjusted 3D rendering for display in adjusted displaying step 250, the 3D rendering of at least one point of the point cloud, which is displayed in the initial or first displaying step 220, is adjusted or enhanced in response to adjusting step 240. Alternatively or in addition, a hyper-adjusted map and an indication thereof are displayed, the hyper-adjusted map includes hyper-points that have at least one attribute which is adjusted in response to a value of another attribute.

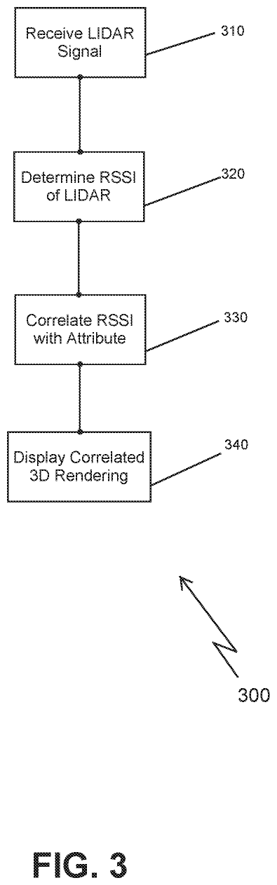

As illustrated in FIG. 3, a further method 300 according to another embodiment includes a receiving step 310 for receiving reflected LIDAR signal 165. Reflected LIDAR signal 165 received by receiving step 310 includes the point cloud of target site 170.

In a determining step 320, the RSSI of reflected LIDAR signal 165 received in step 310 is determined, by for example, LIDAR transceiver 180 which is operatively coupled to processor 110.

In correlating step 330, an attribute of a point on the point cloud is correlated in response to the RSSI identified in determining step 320. The attribute adjusted in correlating step 330 may be one or a combination of any one of an intensity of color, a color, a size and/or on an opacity of at least one point or the point cloud. The attribute may be adjusted by, for example, intensity, color, size and/or opacity modules 125, 130, 135, 140 stored in memory 120 and executed by processor 110. In addition, as previously described, a hyper-adjusted map and an indication thereof are displayed, the hyper-adjusted map includes hyper-points that have at least one attribute which is adjusted in response to a value of another attribute.

In displaying step 340, a correlated, adjusted or enhanced 3D rendering of the point cloud is visualized on display 150 or any other rendering device. In order to obtain the correlated or adjusted 3D rendering for display in step 340, at least one point of the LIDAR point cloud received in step 310 is adjusted or enhanced in response to correlating step 330. For example, the RSSI determined in the step 320 is correlated with an attribute in correlating step 330 in order to obtain the correlated 3D rendering, where at least one attribute of a particular point in the point cloud is changed based on the RSSI of reflected signal 165 reflected from that particular point on target site 170, for display in step 340. Alternatively or in addition, a hyper-adjusted map and an indication thereof are displayed, the hyper-adjusted map includes hyper-points that have at least one attribute which is adjusted in response to a value of another attribute.

The modules, computer programs, instructions and/or program portions contained in the memory may configure the processor to implement the methods, operations, acts, and functions disclosed herein. The processor so configured becomes a special purpose machine or processor particularly suited for performing the methods, operations, acts, and functions. The memories may be distributed, for example, between systems, clients and/or servers, or local, and the processor, where additional processors may be provided, which may also be distributed or may be singular. The memories may be implemented as electrical, magnetic or optical memory, or any combination of these or other types of storage devices. Moreover, the term “memory” should be constructed broadly enough to encompass any information able to be read from or written to an address in an addressable space accessible by the processor. With this definition, information accessible through a network is still within the memory, for instance, because the processor may retrieve the information from the network for operation in accordance with the present system.

It will be appreciated by persons having ordinary skill in the art that many variations, additions, modifications, and other applications may be made to what has been particularly shown and described herein by way of embodiments, without departing from the spirit or scope of the invention. Therefore it is intended that the scope of the invention, as defined by the claims below, includes all foreseeable variations, additions, modifications or applications.

Finally, the above-discussion is intended to be merely illustrative of the present invention and should not be construed as limiting the appended claims to any particular embodiment or group of embodiments. Thus, while the present invention has been described with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A system for rendering an enhanced 3D image, the system comprising:
a processor configured to receive a LIDAR signal having a point cloud representing a target site in three dimensions and to receive a received signal strength indicator (RSSI) for each point of the point cloud;
a memory operatively coupled to the processor, the memory including an intensity module, a size module, and an opacity module; and
a display operatively coupled to the processor,
wherein, the processor is configured to execute: the intensity module to adjust an intensity of color of at least one point of the point cloud; the size module to adjust a size of the at least one point of the point cloud; and the opacity module to adjust an opacity of the at least one point of the point cloud,
wherein, in response to the RSSI, the processor is configured to execute at least one of the intensity, size and opacity modules to adjust at least one of the intensity of color, the size and the opacity of the at least one point to generate the enhanced 3D image of the point cloud,
wherein an increase in the RSSI is configured to cause: the intensity module to increase the intensity of color of the at least one point of the point cloud; the size module to increase the size of the at least one point of the point cloud; and the opacity module to increase the opacity of the at least one point of the point cloud, and
wherein the display is configured to display the enhanced 3D image obtained from the execution of the at least one of the intensity, size and opacity modules.

2. The system of claim 1, wherein at least one of the intensity, size and opacity is adjusted between predetermined minimum and maximum values.

3. The system of claim 1, wherein at least one of the intensity, size and opacity is adjusted in response to a value of another one of intensity, size and opacity being outside predetermined minimum and maximum values.

4. The system of claim 1, wherein the display is configured to display an original 3D rendering of the point cloud of the received LIDAR signal, and wherein the enhanced 3D image is generated by adjusting the original 3D rendering.

5. The system of claim 1, wherein the memory further comprises a color module which when executed by the processor is configured to adjust a color of the at least one point of the point cloud in response to the RSSI to generate the enhanced 3D image.

6. A method for rendering an enhanced 3D image, the method comprising steps of:
receiving, by a processor, a LIDAR signal having a point cloud representing a target site in three dimensions and a received signal strength indicator (RSSI) for each point of the point cloud;
executing, by the processor, in response to the RSSI at least one of: an intensity module to adjust an intensity of color of at least one point of the point cloud; a size module to adjust a size of the at least one point of the point cloud; and an opacity module to adjust an opacity of the at least one point of the point cloud, wherein the intensity, size and opacity modules are stored in a memory operatively coupled to the processor;
generating, by the executing step, the enhanced 3D image of the point cloud,
wherein an increase in the RSSI is configured to cause: the intensity module to increase the intensity of color of the at least one point of the point cloud; the size module to increase the size of the at least one point of the point cloud; and the opacity module to increase the opacity of the at least one point of the point cloud; and
displaying, by a display operatively coupled to the processor, the enhanced 3D image obtained from the executing of the at least one of the intensity, size and opacity modules.

7. The method of claim 6, wherein at least one of the intensity, size and opacity is adjusted between predetermined minimum and maximum values.

8. The method of claim 6, wherein at least one of the intensity, size and opacity is adjusted in response to a value of another one of intensity, size and opacity being outside predetermined minimum and maximum values.

9. The method of claim 6, further comprising displaying, by the display, an original 3D rendering of the point cloud of the LIDAR signal received in the receiving step, and generating, by the executing step, the enhanced 3D image by adjusting the original 3D rendering.

10. A non-transitory computer readable medium storing computer instructions, which when executed by a processor, configure the processor to perform a method for rendering an enhanced 3D image, the method comprising steps of:
receiving, by a processor, a LIDAR signal having a received signal strength indicator (RSSI);
displaying, by a display operatively coupled to the processor, an original 3D rendering of the LIDAR signal received in the receiving step;
executing, by the processor, in response to the RSSI at least one of: an intensity module to adjust an intensity of color of the original 3D rendering; a size module to adjust a size of the original 3D rendering; and an opacity module to adjust an opacity of the original 3D rendering, wherein the intensity, size and opacity modules are stored in a memory operatively coupled to the processor;
generating, by the executing step, an enhanced 3D rendering by adjusting the original 3D rendering,
wherein an increase in the RSSI is configured to cause: the intensity module to increase the intensity of color of the original 3D rendering; the size module to increase the size of the original 3D rendering; and the opacity module to increase the opacity of the original 3D rendering; and
displaying, by the display, the enhanced 3D rendering obtained from the executing of the at least one of the intensity, size and opacity modules.

11. The method of claim 10, wherein at least one of the intensity, size and opacity is adjusted between predetermined minimum and maximum values.

12. The method of claim 10, wherein at least one of the intensity, size and opacity is adjusted in response to a value of another one of intensity, size and opacity being outside predetermined minimum and maximum values.
